(19) United States
(12) Patent Application Publication
(10) Pub. No.: US 2007/0036357 A1
(43) Pub. Date: Feb. 15, 2007

(54) Watermarking of multimedia signals

(75) Inventors: Minne Van der Veen, Eindhoven (NL); Aweke Negash Lemma, Eindhoven (NL); Javier Francisco Aprea, Eindhoven (NL); Alphons Antonius Maria Lambertus Bruekers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/572,621

(22) PCT Filed: Sep. 1, 2004
(86) PCT No.: PCT/IB04/51659

§ 371 Date: Mar. 17, 2006

(30) Foreign Application Priority Data
Sep. 22, 2003 (EP) 03103481.2

(51) Int. Cl. H04N 1/44

(52) U.S. Cl. 380/246

(57) ABSTRACT

The invention concerns a method and apparatus for embedding and detecting watermarks in a digital host signal. In the embedding method a watermark sequence of length Lw/N bits carrying predetermined information is generated and then up-sampled by a factor N (preferably N=2). At intermediate sampling points of the up-sampled sequence a modified version of the watermark sequence (in preferred arrangements the negative thereof) is inserted to form a compound watermark sequence of length Lw. The compound watermark sequence is then combined with the host signal to watermark the host signal. The invention finds particular advantage in that the need for a spectral whitening stage in the detector is done away with.

The present invention relates to apparatus and methods for the watermarking of multimedia signals.

Watermarking of multimedia signals is a technique for the transmission of additional data along with the multimedia signal. For instance, watermarking techniques can be used to embed copyright and copy control information into audio signals.

The main requirement of a watermarking scheme is that it is not observable (i.e. in the case of an audio signal, it is inaudible) whilst being robust to attacks to remove the watermark from the signal (e.g. removing the watermark will damage the signal). It will be appreciated that the robustness of a watermark will normally be a trade off against the quality of the signal in which the watermark is embedded. For instance, if a watermark is strongly embedded into an audio signal (and is thus difficult to remove) then it is likely that the quality of the audio signal will be reduced.

Various types of audio watermarking schemes have been proposed, each with its own advantages and disadvantages. For instance, one type of audio watermarking scheme is to use temporal correlation techniques to embed the desired data (e.g. copyright information) into the audio signal. This technique is effectively an echo-hiding algorithm, in which the strength of echo is determined by solving a quadratic equation. The quadratic equation is generated by auto-correlation values at two positions: one at delay equal to r, and one at delay equal to 0. At the detector, the watermark is extracted by determining the ratio of the auto correlation function at the two delay positions.

WO 00/00969 describes an alternative technique for embedding or encoding auxiliary signals (such as copyright information) into a multimedia host or cover signal. A replica of the cover signal, or a portion of the cover signal in a particular domain (time, frequency or space), is generated according to a stego key, which specifies modification values to the parameters of the cover signal. The replica signal is then modified by an auxiliary signal corresponding to the information to be embedded, and inserted back into the cover signal so as to form the stego signal.

At the decoder, in order to extract the original auxiliary data, a replica of the stego signal is generated in the same manner as the replica of the original cover signal, and requires the use of the same stego key. The resulting replica is then correlated with the received stego signal so as to extract the auxiliary signal.

In such watermarking schemes the additional data to be embedded within the multimedia signal typically takes the form of a sequence of values. This sequence of values is then converted into a slowly varying narrow-band signal by applying a window shaping function to each value.

U.S. Pat. No. 5,822,360 (Chong U.Lee) provides a method and apparatus for the transporting of auxiliary data in audio signals. Particularly, this disclosure provides a method for hiding auxiliary information in an audio signal for communication to a receiver. A Pseudo random noise carrier (having a flat spectrum) is modulated by an auxiliary information to provide a spread spectrum signal carrying the information. The audio signal is evaluated to determine its spectral shape. A carrier portion of the spread spectrum signal is spectrally shaped to simulate the spectral shape of the audio signal. The spread spectrum signal having the spectrally shaped carrier portion is combined with the audio signal to produce an output signal carrying the auxiliary information. To recover the auxiliary information from the output signal, first the spectral shape of the output signal is determined. Based on the determined spectral shape, the output signal is then processed to flatten (i.e., “whiten”) the carrier portion of the spread spectrum signal contained in it.

It is an aim of embodiments of the present invention to provide alternative methods and apparatus for embedding watermarks in multimedia signals which permit less complex detection.

It is a further aim of embodiments of the invention to provide watermark detection without the need for an explicit spectral whitening stage.

According to a first aspect of the invention, there is provided a method for embedding watermarks in a digital host signal carrying signal information, the method comprising the steps of: generating a watermark sequence of length Lw/N symbols carrying predetermined information; up-sampling the watermark sequence by a factor of N; at intermediate sampling points of the up-sampled sequence inserting a modified version of the watermark sequence to form a compound watermark sequence of length Lw; and combining the compound watermark sequence with the host signal to watermark the host signal.

In the above method, the combination of a watermark sequence together with an appropriately modified version of itself to form a compound watermark sequence enables the watermark to be conditioned in such a way that the DC component of the random watermark sequence is minimised.

Preferably, N is 2.

Limiting the up-sampling factor to 2 provides a low complexity.

Preferably, the modified version of the watermark sequence is arranged such that the compound watermark sequence is bi-polar.

Preferably, the modification is selected with a view to reducing or minimising the DC component of the compound watermark.

Preferably, inserting the modified version of the watermark sequence comprises inserting a negative version of the generated watermark sequence at intermediate sampling points to form a bipolar up-sampled sequence.

A bi-polar signal of the above-described type is advantageous as the DC component is minimized irrespective of the underlying watermark sequence. As useful information is not carried within the DC component, any reduction in DC component is desirable.

Preferably, inserting the modified version comprises, for each intermediate point of the up-sampled watermark sequence, inserting a negative version of a neighbouring sampled value of the watermark sequence.

Preferably, the method for embedding of a watermark comprises a transform domain (e.g. FFT, DCT, MDCT, etc.) coefficients modulating method.

According to a second aspect of the invention, there is provided a watermark decoding method comprising the steps of: receiving a watermarked host signal; detecting a compound watermark sequence within the watermarked host signal; splitting the compound watermark sequence into at least two groups of sample values corresponding to a watermark sequence and a modified version of the watermark sequence; and performing an inverse modification of the watermarked sequence in order to retrieve predetermined information carried by it.

Preferably, detecting the compound watermark sequence within the watermarked host signal comprises the steps of computing the absolute values of the received transform domain coefficients and performing a smoothing operation on them.

Preferably, the smoothing operation comprises averaging the computed absolute values, preferably in an accumulator, to form an averaged transform domain signal.

Preferably, the compound watermark sequence comprises transform domain coefficients and the step of splitting comprises splitting the transform domain coefficients into at least two (say N) groups (sequences) comprising information at appropriately down sampled points within the compound watermark sequence.

Preferably, the step of splitting comprises applying the averaged transform domain signal to N signal paths, each signal path comprising a down sampler of factor N and each signal path being delayed with respect to the preceding one so as to split the averaged transform domain signal into N disjoint sequences.

Preferably, N=2 and the step of splitting comprises splitting the transform domain coefficients to assemble a first sequence comprising information at odd sampling points within the compound watermark, and a second sequence comprising information at even sampling points within the compound watermark sequence.

Preferably, performing an inverse modification of the watermark sequence comprises taking the difference between the corresponding sample values of the first and second sequences and normalizing with respect to the sum of corresponding sample values of the first and second sequences.

The invention includes a watermarked host signal, wherein the watermark comprises a compound watermark comprising a combination of up-sampled sequence of a watermark and modified versions of the same watermark.

Preferably, the modification is chosen so as to reduce the DC component of the compound watermark.

Preferably, the compound watermark is generated by up-sampling the watermark and inserting the modified versions at the intermediate sampling points generated by the up-sampling.

In one preferred embodiment, the up-sampling factor is 2, and the modified version is the inverse of the watermark signal.

A further aspect of the invention provides an apparatus for embedding watermarks in a digital host signal carrying signal information, the apparatus comprising: a watermark sequence generator for generating a watermark sequence, an up-sampler for up-sampling the watermark sequence by a factor of N; means for generating a compound watermark sequence by inserting a modified version of the watermark sequence into intermediate sampling points created by the up-sampling process; and an embedder for applying the compound watermark signal to a host signal.

Preferably, the up-sampler comprises a two times up-sampler.

Preferably, the means for forming a compound watermark comprises an FIR filter with an impulse response B[m]=[−1,1].

Preferably, the watermark sequence comprises an FFT block.

According to yet another aspect of the invention, there is provided a watermark decoding apparatus, the apparatus comprising: means for receiving a watermarked host signal; means for detecting a compound watermark sequence within a the watermarked host signal; means for splitting the compound watermark sequence into at least first and second sequences corresponding to a watermark sequence and a modified version of the watermark sequence; and inverse modification means for performing an inverse modification of the watermark sequence in order to retrieve predetermined information carried by it.

Preferably, the means for detecting a compound watermark sequence within the watermarked host signal comprises a filter for separating out FFT coefficients of the compound watermark sequence from a received watermarked host signal.

Preferably, the means for detecting the compound watermark sequence further comprises absolute value computation means for providing absolute values of FFT coefficients.

Preferably, the means for detecting the compound watermark sequence further comprises smoothing means for averaging the computed absolute values. The smoothing means preferably comprises an accumulator.

Preferably, the means for splitting the compound watermark sequence comprise first and second signal processing means, the first signal processing means being provided in a first signal path and the second signal processing means being provided in a second signal path, each signal processing means comprising a down-sampler of factor N and one of the first or second signal processing means further comprising delay means so as to split the averaged transform domain signal into the first and second sequences.

Preferably, the means for performing the inverse modification of the watermark sequence comprises modification means arranged to take the difference between corresponding sample values of the first and second sequence and to normalise with respect to the sum of corresponding sample values of the first and second sequence.

For a better understanding of the invention, and to show how embodiments of the same may be carried into effect, reference will now be made, by way of example, to the accompanying diagrammatic drawings in which:

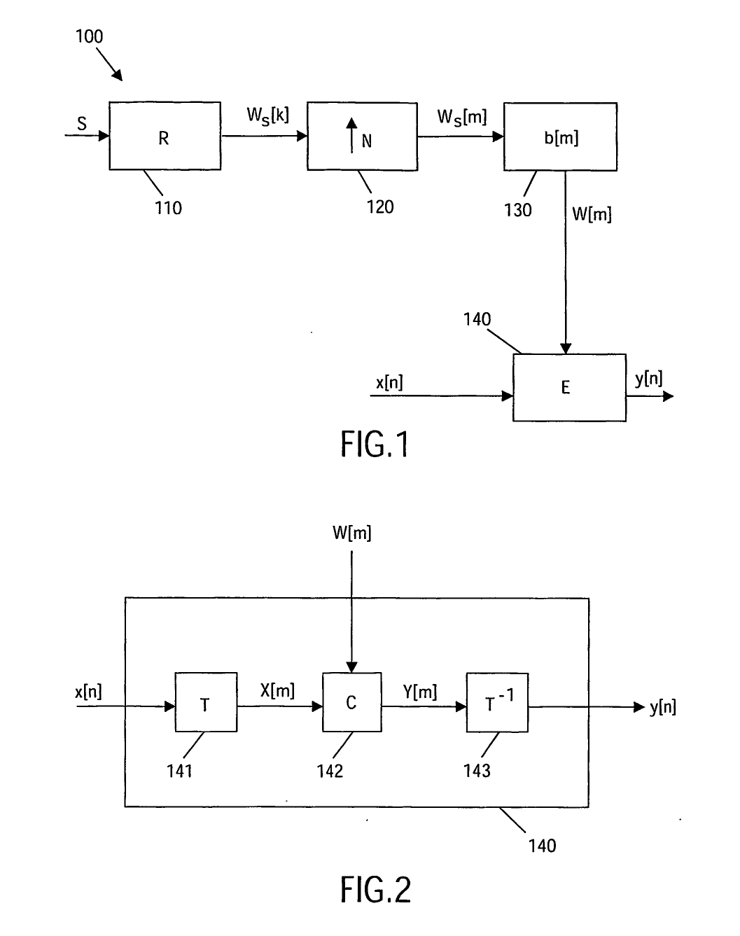

FIG. 1 is a schematic diagram illustrating the formation of a compound watermark sequence and the embedding thereof into a host signal in accordance with embodiments of the invention;

FIG. 2 is a schematic diagram showing detail of a generalised watermark embedder for use in embodiments of the invention;

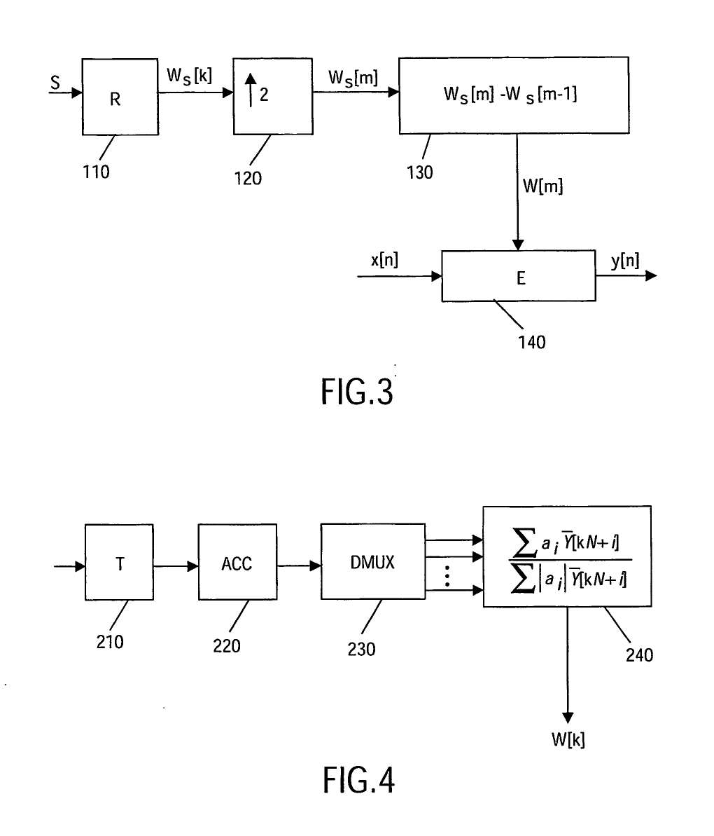

FIG. 3 is a schematic diagram showing the formation of a watermark sequence and embedding in a preferred embodiment;

FIG. 4 illustrates methods and apparatus involved in the detection of watermarks in accordance with embodiments of the invention;

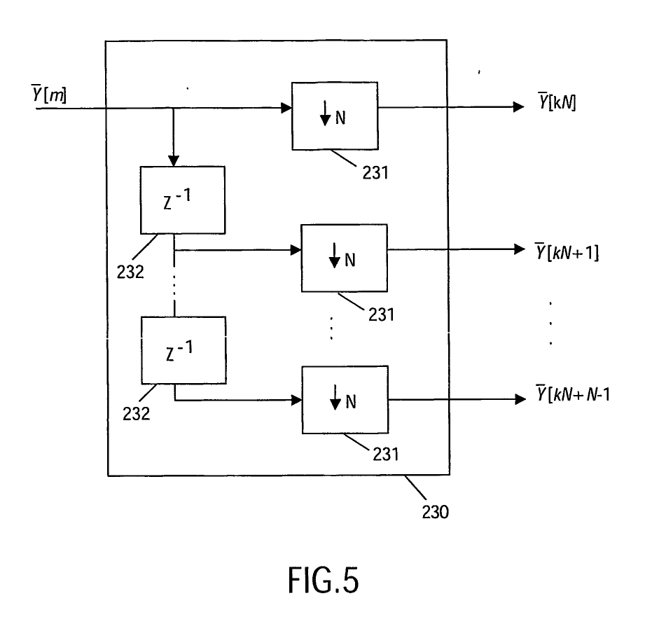

FIG. 5 shows detail of a de-multiplexing stage of a watermark detector; and

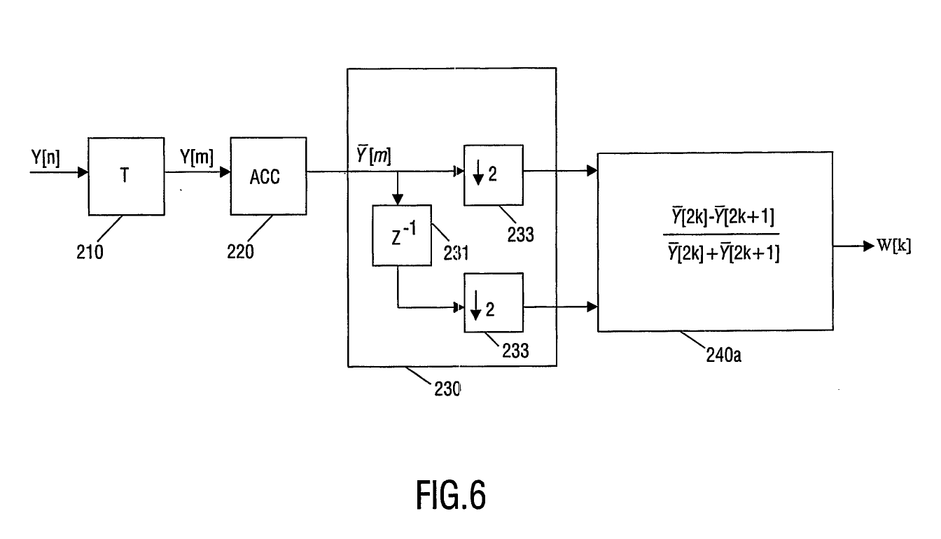

FIG. 6 shows a watermark detector for a preferred embodiment.

The basic schematic representation for embedding watermarks in accordance with methods and apparatus of the present invention is shown in FIG. 1.

In FIG. 1, the embedding apparatus 100 comprises a random watermark sequence generator R 110 for generating a watermark sequence Wₛ[k] using a key S, an up-sampler ↑N 120 for up-sampling the sequence Wₛ[k] by a factor of N, a modification module B[m] 130 for creating a compound watermark sequence W[m] formed by inserting modified versions of the watermark sequence Wₛ[k] into intermediate sampling points generated by the up-sampling operation and an embedder E 140 for applying the watermark signal to a multimedia type host signal x[n] to provide a watermarked host signal y[n].

FIG. 2 shows the embedder E 140 in more detail. The watermark embedder 140 comprises a first transformation module T 141, a combining module C 142 and an inverse transformation module T¹ 143.

Transform module T 141 receives the host signal x[n] in whatever format it might be and transforms the signal to a signal X[m] compatible with the chosen format of the compound watermark sequence W[m]. Combining module C 142 combines the compound watermark sequence W[m] with the signal W[m] in the appropriate common transform domain to form a watermarked host signal Y[m] and inverse transformation module T¹ 143 converts the watermarked host signal back to the appropriate, original type format (domain) of the host signal.

FIG. 3 will now be described which shows a special case of the FIG. 1 schematic in which up-sampling by a factor of 2 is performed upon an FFT type watermark sequence.

In more detail, a watermark sequence Wₛ[k] of length Lw/2 is generated by the random watermark generator R 110 using the input key S, where Lw is the total number of required FFT points. The so-generated sequence is then up sampled by the up-sampler 120 by a factor 2, and subsequently passed to modification module 130 whose transfer function is shown as Wₛ[m]-Wₛ[m-1] to produce a compound watermark sequence of FFT block length Lw in which both a positive and a negative version of the original watermark sequence Wₛ[k] are present. The resulting watermark is like:

$$w [ k ] = \{ \begin{matrix}{w}_{s} [ k / 2 ] , & k = 2 m \\ - {w}_{s} [ ( k - 1 ) / 2 \} , & k = 2 m + 1\end{matrix}$$

Finally, this watermark sequence is embedded into the host signal x[n] at the embedder E 140 to give a watermarked host signal y[n] using one of the known transform domain watermarking schemes.

The up-sampling process generates empty sample points intermediate the actual values given by the watermark sequence Lw/2. The modification module 130 may comprise an FIR filter of response B[m]=(−1,1). In performing the modification, these empty intermediate sample points are filled by an appropriately modified version of the watermark. Here, such an appropriate modification comprises the negative of the watermark sequence such that the sample points comprise negative counterparts to the sample points of the original watermark. In this way, the up-sampled sequence as a whole forms a bipolar signal, the average level of which is substantially zero.

An original watermark of, for example, 512 bits gives an FFT block size of watermark sequence Wₛ[k] of 2×512=1024 bits and up-sampling this FFT block by a factor of two doubles the block size to 2048 bits—which is an acceptable and typical FFT block length for spectral domain watermarks.

In the general case, where N may be any up-sampling factor, the modification applied by module 130 is any appropriate modification chosen to produce a compound watermark sequence in which the DC component of the compound sequence is reduced (preferably minimised).

In effect, in the specific case where N=2, the up-sampling and modification as described above of an essentially randomised watermark signal brings about the insertion of a negative sampled version of the FFT sequence into the intermediate sample points to reduce or remove the DC component from the compound watermark sequence.

FIG. 4 shows a generalised watermark detection method and apparatus.

Essentially, the detection method comprises the steps of:

Computing the absolute values of the transform domain (FFT) coefficients

Accumulating the computed transform domain coefficients (smoothing stage)

Splitting the accumulated intermediate values into appropriate values

Estimating (extracting) the watermark sequence.

In more detail, in FIG. 4, a detector 200 comprises a transformation unit T 210, accumulator ACC 220, demultiplexing stage DMUX 230 and inverse modification module 240.

The transformation unit T 210 transforms the signal at its input to a domain that is compatible with the watermark signal, and outputs the magnitude (spectrum) Y[m] of the transform domain sequence. The sequence Y[m] is then provided to the accumulator ACC 220 to obtain the averaged (smoothed) transform domain signal Y̅[m]= X̅[m](1+w[m]), which is in turn passed to the 1 to N demultiplexing stage DMUX 230 to provide N sequences or groups.

Referring to FIG. 5, which shows the demultiplexing stage 230 in detail, the averaged transform domain signal Y̅[m], is input to the demultiplexing stage in which a N−1 serially arranged delay elements Z⁻¹ 232 separate the signal into N sequences, each of which is then down-sampled by the down sampler 231 to provide a plurality of N sequences of the form Y̅[kN], Y̅[kN+1] . . . Y̅[kN+(N−1)].

Returning to the FIG. 4 decoder, the N sequences generated by the demultiplexing stage 230 are input to the inverse modification module 240 which performs the following operation:

$${W}_{s} [ k ] \approx \frac{{\sum }_{i = 0}^{N - 1} {a}_{i} Y [ Nk + i ]}{{\sum }_{i = 0}^{N - 1} \vert {a}_{i} \vert Y [ Nk + i ]}$$

to restore the original watermark sequence. The working of the above expression is given as follows.

In the general case, where we start (at the embedder) with a watermark sequence of length Lw/N followed by a factor N up-sampler and an FIR filter B[m] with the impulse response

$$b [ m ] = {\sum }_{i = 0}^{N - 1} {a}_{i} δ [ m - i ]$$

where the coefficients αᵢ are such that the sums

$${\sum }_{i - 0}^{N - 1} {a}_{i} and {\sum }_{i - 0}^{N - 1} {a}_{i} \vert {a}_{i} \vert$$

are both substantially close to zero. The coefficients in the appropriate domains are assumed to be modified according to the expression Y[Nk+i]=X[Nk+i](1+αᵢw[k]), for k=1 . . . Lw/N and i=0 . . . N−1.

At the detector side, assuming X[k] is sufficiently correlated, the watermark symbol W[k] is estimated using the expression

$${W}_{s} [ k ] \approx \frac{{\sum }_{i = 0}^{N - 1} {a}_{i} Y [ Nk + i ]}{{\sum }_{i = 0}^{N - 1} \vert {a}_{i} \vert Y [ Nk + i ]}$$

The proof of the above expression follows by replacing Y[Nk+i]=X[Nk+i](1+ᵢw[k]) and noting that

$${\sum }_{i - 0}^{N - 1} {a}_{i} and {\sum }_{i - 0}^{N - 1} {a}_{i} \vert {a}_{i} \vert$$

are both substantially close to zero.

Referring to FIG. 6 now, a specific example of detector 200 where N=2, α₀=1 and a₁=−1.

The detector 200 comprises transformation unit T 210 that computes the magnitude of the FFT coefficients Y[m] of the input potentially watermarked signal y[n]. The sequence Y[m] is then provided to the accumulator ACC 220 to obtain the averaged (smoothed) spectral signal Y̅[m]= X̅[m](1+w[m]).

Subsequently, for k=1, . . . ,Lw/2, the even Y̅[2k]≈ X̅[2k](1+w[2k]) and the off Y̅[2k+1]≈ X̅[2k+1](1+w[2k+1]) samples of the FFT coefficients are split in the demultiplexer 230a using a delay 231 and two down-sampler 233 combination for the odd samples and even samples. From the embedding method one can clearly see that W[2k]≈Wₛ[k] and W[2k+1]≈−Wₛ[k], respectively, i.e.,
Y̅[2k]≈ X̅[2k](1+W_{S}[k])
Y̅[2k+1]≈ X̅[2k+1](1−W_{S}[k])

Thus, assuming that X̅[2k]≈ X̅[2k+1] (i.e., X is correlated), we obtain the following approximation for Wₛ[k]:

$${W}_{S} [ k ] \approx \frac{\overline{Y} [ 2 k ] - \overline{Y} [ 2 k + 1 ]}{\overline{Y} [ 2 k ] + \overline{Y} [ 2 k + 1 ]}$$

Therefore, the inverse modification module 240a provides the above transfer function to retrieve Wₛ[k].

Note that, for this implementation, there is no need for an extra whitening stage, the signal is automatically whitened by the above expression. After the watermark sequence is estimated, it is correlated with a reference watermark and the resulting correlation peak is compared against a threshold to determine the detection truth-value.

It will be appreciated that numerous modifications to the invention may be made without departing from the scope of the invention.

Whilst the examples are illustrated with respect to transform domain watermarking, it may be applied to temporal domain watermarking (for instance, embedding a watermark in the temporal domain where the signal contains only a slowly varying portion of the host signal).

Also, whilst a random watermark sequence is mentioned, it will be appreciated that the teachings of the invention are equally applicable to non-random watermarking techniques as, in each case, the DC content of the watermark sequence is substantially eliminated and the need of spectral whitening as discussed above may be avoided.

Whilst the functionality of the embedding and detecting method and apparatus has been described, it will be appreciated that the apparatus could be realised as a digital circuit, an analog circuit, a computer program, or a combination thereof.

Equally, it will be appreciated that the teachings of the invention may be applied to a broad range of signal types such as, but not limited to, audio, video, audio/video and data type signals.

Within the specification it will be appreciated that the word “comprising” does not exclude other elements or steps, that “a” or “and” does not exclude a plurality, and that a single processor or other unit may fulfil the functions of several means recited in the claims.

1. A method for embedding watermarks in a digital host signal carrying signal information, the method comprising the steps of:
generating a watermark sequence of length Lw/N bits carrying predetermined information;
up-sampling the watermark sequence by a factor of N;
at the intermediate sampling points of the up-sampled sequence inserting a modified version of the watermark sequence to form a compound watermark sequence of length Lw; and
combining the compound watermark sequence with the host signal to watermark the host signal.

2. The method of claim 1, wherein N is 2.

3. The method of claim 1 or 2, wherein the modified versions of the watermark sequence are arranged such that the compound watermark sequence is bi-polar.

4. The method of claim 1, 2 or 3, wherein the modification for generating the modified versions is chosen such that the DC component of the compound watermark sequence is reduced or minimised.

5. The method of any preceding claim, wherein inserting the modified version of the watermark sequence comprises inserting a negative version of the said watermark sequence at intermediate sampling points so as to form a bipolar up-sampled sequence.

6. The method of any of the preceding claims, wherein inserting the modified versions comprises, for each intermediate point of the up-sampled watermark sequence, inserting a negative version of a neighbouring sampled value of the watermark sequence.

7. The method of any preceding claim, wherein the method for embedding of a watermark in the sequence comprises a transform domain coefficients modulating method.

8. Method as in claim 7, where the transform is FFT.

9. A watermark decoding method comprising the steps of:
receiving a watermarked host signal;
detecting a compound watermark sequence within the watermarked host signal;
splitting the compound watermark sequence into at least two groups of sample values corresponding to a watermark sequence and a modified version of the watermark sequence; and
performing inverse modification of the watermarked sequence in order to retrieve predetermined information carried by it.

10. The method of claim 9, wherein detecting the compound watermark sequence within the watermarked host signal comprises computing absolute values of received transform domain coefficients and performing a smoothing operation on them.

11. The method of claim 10, wherein the smoothing operation comprises averaging the computed absolute values to form an averaged transform domain signal.

12. The method of any of claims 9 to 11, wherein the compound watermark sequence comprises transform domain coefficients and the step of splitting comprises splitting the transform domain coefficients to assemble a first sequence comprising information at odd sampling points within the compound watermark sequence, and a second sequence comprising information at even sampling points within the compound watermark sequence.

13. The method of claim 9, wherein the step of splitting comprises applying the averaged transform domain signal to first and second signal paths, each signal path comprising a factor 2 down sampler and one signal path being delayed with respect to the other so as to split the averaged transform domain signal into the first and second sequences.

14. The method of claim 9, wherein performing the inverse modification of the watermark sequence comprises taking the difference between the corresponding sample values of the first and second sequence and normalizing with respect to the sum of corresponding sample values of the first and second sequence.

15. A watermarked host signal, wherein the watermark comprises a compound watermark comprising a combination of an up-sampled sequence of a watermark and a modified version of the same watermark.

16. The watermarked host signal of claim 15, wherein the modification is chosen so as to reduce or minimise a DC component of the compound watermark.

17. The watermarked host signal of claim 15 or 16, wherein the compound watermark is generated by up-sampling the watermark and inserting the modified version of the watermark at the intermediate sampling points generated by the up-sampling.

18. The watermarked host signal of claim 15, 16 or 17, wherein where an up-sampling factor is chosen to be 2, the modified version comprises the inverse of the watermark

19. An apparatus for embedding watermarks in a digital host signal carrying signal information, the apparatus comprising:
a watermark sequence generator (110) for generating a watermark sequence, an up-sampler (120) for up-sampling the watermark sequence by a factor of N;
means for generating a compound watermark sequence by inserting a modified version of the watermark sequence into intermediate sampling points created by the up-sampling process; and
an embedder (140) for applying the compound watermark signal to a host signal.

20. The apparatus of claim 19, wherein the modification is chosen so as to reduce or minimise a DC component of the compound watermark.

21. The apparatus of claim 19 or 20, wherein the up-sampler comprises a two times up-sampler.

22. The apparatus of claim 20, wherein the means for forming a compound watermark comprises an FIR filter with a response B[m]=[−1,1].

23. The apparatus of claim 19, 20, 21 or 22, wherein the watermark sequence comprises an FFT block.

24. A watermark decoding apparatus, the apparatus comprising:
means for receiving a watermarked host signal;
means for detecting a compound watermark sequence within the watermarked host signal;
means for splitting the compound watermark sequence into at least first and second sequences corresponding to a watermark sequence and a modified version of the watermark sequence; and
inverse modification means for performing an inverse modification of the watermark sequence in order to retrieve predetermined information carried by it.

25. The apparatus of claim 24, wherein the means for detecting a compound watermark sequence within the watermarked host signal comprises a filter (210) for separating out FFT coefficients of the compound watermark sequence from a received watermarked host signal.

26. The apparatus of claim 24 or 25, wherein the means for detecting the compound watermark sequence comprises absolute value computation means for providing absolute values of FFT coefficients.

27. The apparatus of claim 24, 25 or 26, wherein the means for detecting the compound watermark sequence comprises smoothing means for averaging the computed absolute values.

28. The apparatus of claim 27, wherein the smoothing means comprises an accumulator (220).

29. The apparatus of any of claims 24 to 28, wherein the means for splitting the compound watermark sequence comprise first and second signal processing means, the first signal processing means being provided in a first signal path and the second signal processing means being provided in a second signal path, each signal processing means comprising a down-sampler (240,250) of factor N and one of the first or second signal processing means further comprising delay means (230) so as to split the averaged transform domain signal into the first and second sequences.

30. The apparatus of any of claims 24 to 29, wherein the means for performing the inverse modification of the watermark sequence comprises modification means arranged to take the difference between corresponding sample values of the first and second sequence and normalise with respect to the sum of corresponding sample values of the first and second sequence.
